(19) United States
(12) Patent Application Publication
(10) Pub. No.: US 2024/0414819 A1
(43) Pub. Date: Dec. 12, 2024

(54) DYNAMIC COLOR TEMPERATURE CONTROL OF LIGHTING

(71) Applicant: Videndum Production Solutions Inc., Shelton, CT (US)

(72) Inventors: David Pasko, Middlebury, CT (US); Michael Herbert, London (GB); Timothy Sei Jin Kang, Glendale, CA (US); Matthew Salvatore Robert Santoro, Niagara Falls (CA); Benjamin Dynice, Long Beach, CA (US)

(21) Appl. No.: 18/736,716

(22) Filed: Jun. 7, 2024

Related U.S. Application Data
(60) Provisional application No. 63/507,291, filed on Jun. 9, 2023.

(51) Int. Cl. H05B 45/20; G06F 3/0484; H05B 47/175

(52) U.S. Cl. CPC H05B 45/20; H05B 47/196; G06F 3/0484

(57) ABSTRACT

In one embodiment, a controller for dynamically adjusting a color temperature of a light is provided. The controller includes at least one driver, at least one communication interface, and at least one processor. The driver(s) are configured to modify an operation of at least one LED of the light. The processor(s) are configured to receive, via the communication interface(s), a plurality of RGB pixel values for output at the light, identify a target color temperature for the light, generate one or more matrix transforms based on the target color temperature, process the plurality of RGB pixel values using the matrix transforms to generate a plurality linear light values, and modify, utilizing the driver(s), an operation of the LED based on the plurality of linear light values to implement the target color temperature at the light.

### CROSS-REFERENCE TO RELATED APPLICATIONS

This application claims priority to U.S. Provisional Patent Application No. 63/507,291, filed Jun. 9, 2023, and titled “DYNAMIC COLOR TEMPERATURE CONTROL OF LIGHTING”, which is hereby incorporated by reference in its entirety.

### BACKGROUND

The field of the disclosure relates to lighting, and more particularly, to image-based lighting (IBL) for still picture, video, and film production environments.

Lighting systems are used in many scenarios to provide high-quality lighting for use in still picture, video, and film production environments. An array of light emitting diodes (LEDs) may be arranged on a LED light to provide the desired lighting. LEDs are energy efficient and last longer than other types of lighting systems, such as incandescent lights or fluorescent lights.

IBL is often used in production environments, such as a movie set or a television studio, in order in order to enhance the visual impact on actors in front of backgrounds that are graphical, still images, and/or video, and for virtual objects projected near the actors in a scene.

In order to implement IBL, RGB pixel values are sent to lights to illuminate the actors based on the graphical, still images, video, and virtual objects projected near the actors in a scene. However, when the cameras used for image capture are set to a specific white balance, variations in the color temperature output of the light can negatively impact the quality of the still picture, video, and film recorded by the camera.

Thus, it would be desirable to provide mechanisms for ensuring that lighting used in IBL generates light that more closely matches the white balance setting on the cameras used to capture still picture, video, and film in IBL production environments.

### BRIEF DESCRIPTION

In one embodiment, a controller for dynamically adjusting a color temperature of a light is provided. The controller includes at least one driver, at least one communication interface, and at least one processor. The at least one driver is configured to modify an operation of at least one LED of the light. The at least one processor is configured to receive, via the at least one communication interface, a plurality of RGB pixel values for output at the light, identify a target color temperature for the light, generate one or more matrix transforms based on the target color temperature, process the plurality of RGB pixel values using the one or more matrix transforms to generate a plurality linear light values, and modify, utilizing the at least one driver, an operation of the at least one LED based on the plurality of linear light values to implement the target color temperature at the light.

In another embodiment, a method operable by a controller of a light of dynamically adjusting a color temperature of the light is provided. The method includes receiving, via at least one communication interface of the controller, a plurality of RGB pixel values for output at the light. The method further includes identifying a color temperature for the light, generating one or more matrix transforms based on the target color temperature, and processing the plurality of RGB pixel values using the one or more matrix transforms to generate a plurality linear light values. The method further includes modifying, utilizing at least one driver of at least one LED of the light, an operation of the at least one LED based on the plurality of linear light values to implement the target color temperature at the light

In another embodiment, a system including a light and a controller is provided. The light includes at least one LED and the controller includes at least one driver configured to modify an operation of the at least one LED. The controller is configured to identify a target color temperature for the light, and generate one or more matrix transforms based on the target color temperature, where the one or more matrix transforms include a Bianco Schettini positivity constraint matrix and a chromatic adaptation matrix, and where the chromatic adaptation matrix has terms based on a ratio of the target color temperature and a color temperature of the plurality of RGB pixel values. The controller is further configured to process the plurality of RGB pixel values using the one or more matrix transforms to generate a plurality of linear light values, and to modify, utilizing the at least one driver, the operation of the at least one LED based on the plurality of linear light values to implement the target color temperature for the light.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 depicts a block diagram of a system for dynamically adjusting a color temperature of a light in an exemplary embodiment.

FIG. 2 depicts a block diagram of a controller for the light of the system of FIG. 1 in an exemplary embodiment.

FIG. 3 depicts a flow chart of a method operable by a controller of a light for dynamically adjusting a color temperature of the light in an exemplary embodiment.

FIG. 4 depicts a flow diagram for dynamically adjusting a color temperature of the light in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a non-transitory computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

In the human visual system, adaptation may be considered as a dynamic mechanism that optimizes the visual response to a particular viewing condition. Dark and light adaptation are the changes in the visual sensitivity when the level of illumination is increased or decreased. Chromatic adaptation is the ability of the human visual system to discount the color of the illumination and to approximately preserve the appearance of an object. Although daylight is bluer because it includes more short-wavelength energy than indoor lighting, a white object retains its white appearance under both light sources for a viewer as long as the viewer is adapted to the light sources.

Image capture systems, such as digital cameras, do not have the ability to adapt to an illumination source. Rather, the digital camera is set with a white point or white balance which defines the color temperature at which objects should appear white. However, problems can arise when the lights used in IBL output a color temperature that differs from the white balance setpoint on the digital camera, which can negatively impact the quality of the captured images. For example, when RGB pixel values are sent to a light for implementing IBL, the color temperature of the RGB pixel values may differ from the white balance set point on the digital camera, which may cause problems.

In the embodiments described herein, systems and a method are provided that process incoming RGB pixel values for a light in order to output a pre-defined color temperature at the light. This ensures that the light outputs a color temperature that matches the white point settings on the digital cameras used when recording or capturing images in the IBL environment. This color temperature correction operates independently of the actual color temperature of the RGB data being sent to the light. These and other features will be discussed in more detail below.

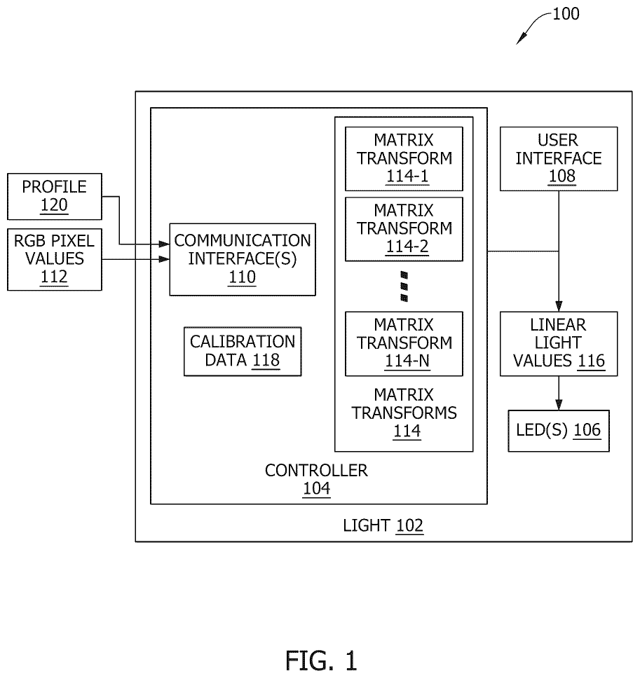

FIG. 1 depicts a block diagram of a system 100 for dynamically adjusting a color temperature of a light 102 in an exemplary embodiment. In some embodiments, system 100 is implemented in an audio/visual IBL environment. For example, system 100 may be implemented in a still picture, a film, a television production environment, and/or a performance environment (e.g., a concert), etc., where IBL is used.

Although system 100 depicts one light 102 in this embodiment, system 100 may include a different number of lights 102 in other embodiments. Light 102 may include multiple controllable color channels, each color channel configurable to vary a brightness of their color in order to vary the color temperature and/or brightness and/or spectral output of light 102.

In this embodiment, light 102 includes a controller 104 that controls the operation of light 102 and communicates with external devices (e.g., a user device, such as a smart phone, lighting control panels, tablets, personal computers, etc.)

Controller 104 and light 102 comprise any component, system, or device that performs the functionality described herein for controller 104 and light 102. Controller 104 and light 102 will be described with respect to various discrete elements, which perform functions. These elements may be combined in different embodiments, segmented into different discrete elements in other embodiments, or removed in some embodiments.

In some embodiments, light 102 further includes a user interface 108 which allows the end-user to control the operation of light 102. User interface 108 may include displays, buttons, software defined buttons, etc., which may allow the end-user to navigate through various menu options presented by controller 104, such as menu options that allow the end-user to select a target output color temperature for light 102.

In this embodiment, light 102 further includes one or more LEDs 106, which generate an optical output for light 102. LEDs 106 may be organized into various color channels, with each color channel individually modifiable by controller 104 to vary the color temperature and/or brightness and/or spectral output of light 102.

In this embodiment, controller 104 includes one or more communication interfaces 110 that receives RGB pixel values 112 for output at light 102. For example, RGB pixel values 112 may define the red, green, and blue values used to modify the operation of the corresponding red, blue, and green LEDs 106 at light 102. Communication interface 110 may comprise wired interfaces, wireless interfaces, and combinations thereof. Some examples of communication interfaces 110 include Wi-Fi, Ethernet, digital multiplex (DMX) compatible interfaces, cellular network interfaces, etc.

In this embodiment, controller 104 dynamically adjusts the output color temperature of light 102 using one or more matrix transforms 114, which are used to process RGB pixel values 112 received by controller 104 and generate linear light values 116 for output by LEDs 106.

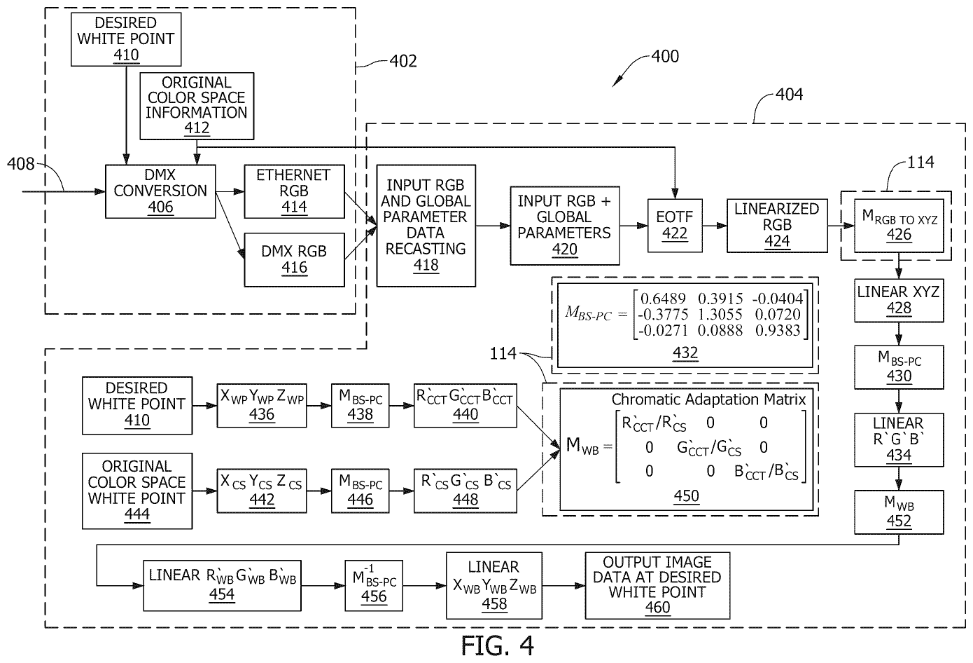

Although three matrix transforms 114-1, 114-2, 114-N are depicted in FIG. 1, controller 104 may utilize a different number of matrix transforms 114 in other embodiments. Matrix transforms 114 may comprise, for example, color space transforms, chromatic adaptation transforms, and the like. Some examples of color space transforms include RGB color space transforms to or from XYZ color space, XYZ color space transforms to or from long, medium, short (LMS) color space, RGB color space transforms to or from LMS color space, etc. Some examples of chromatic adaptation transforms include von Kries based chromatic adaptation transforms and Bianco Schettini positivity constraint transforms. In some embodiments, matrix transforms 114 comprise a chromatic adaptation matrix having terms based on a ratio of the target color temperature and a color temperature of RGB pixel values 112. This will be discussed later with respect to FIG. 4.

In some embodiments, converted RGB pixel values 112 are generated based on a plurality of processing steps in a process flow. RGB pixel values 112 may be processed using an electro-optical transfer function (EOTF) for light 102. An EOTF is a transfer function having picture or video signals as an input that converts the signals into linear light values for output at light 102. The linear light values output by the EOTF may then be processed by one or more matrix transforms 114 in a sequence to convert linear RGB data output by the EOTF to linear light data for LED drivers 208. The one or more matrix transforms 114 may convert linear RGB to linear XYZ, and linear XYZ to linear R′G′B′ generated by a Bianco Schettini positivity constraint transform. Further, matrix transforms 114 may be generated that use a chromatic adaptation matrix to modify linear R′G′B′ based on a relationship between a desired white point at light 102 and the white point defined by RGB pixel values 112 and/or a color space associated with RGB pixel values 112.

In this embodiment, controller 104 further includes calibration data 118 for light 102, which specifies a pre-defined spectral output of light 102. For example, calibration data 118 may be generated during a calibration process of light 102 when light 102 is calibrated during manufacturing to achieve a pre-defined spectral output that accurately represents the RGB pixel values 112 received by light 102.

In some embodiments, controller 104 receives one or more profiles 120, which may specify a target color temperature for light 102 when outputting RGB pixel values 112. During operation of light 102, controller 104 uses the target color temperature to generate one or more of matrix transforms 114, which are then used to process RGB pixel values 112 and generate linear light values 116 for output by LEDs 106. In other embodiments, controller 104 receives information regarding the target color temperature for light 102 as metadata associated with RGB pixel values 112.

For example, if profile 120 or the metadata specifies a target color temperature of light 102 as five thousand kelvin, then controller 104 uses five thousand kelvin as the target color temperature for light 102 to generate one or more of matrix transforms 114, which are then used to process RGB pixel values 112 to generate linear light values 116 in order to generate an optical output at the target color temperature at light 102.

In one embodiment, the end-user may operate user interface 108 to set the target color temperature of light 102. For example, the end-user may utilize various menu options presented by user interface 108 in order to select or input the target color temperature at light 102. In some embodiments, profile 120 comprises a DMX profile, and RGB pixel values 112 and/or profile 120 are included in one or more DMX messages sent to light 102.

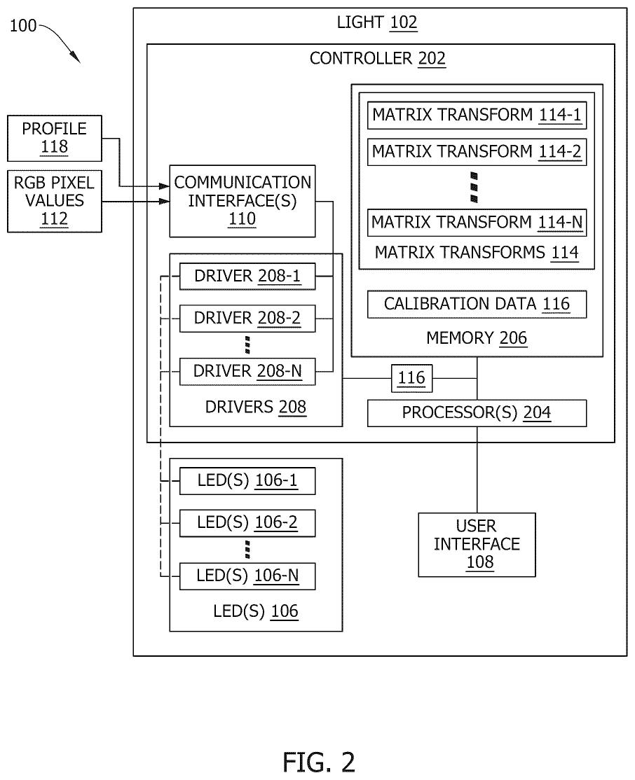

FIG. 2 depicts a block diagram of a controller 202 for light 102 in another exemplary embodiment. Controller 202 comprises any component, system, or device that performs the functionality described herein for controller 202. Controller 202 will be described with respect to various discrete elements, which perform functions. These elements may be combined in different embodiments, segmented into different discrete elements in other embodiments, or removed in some embodiments. Controller 202 may operate the same or similar as to controller 104 as described with respect to FIG. 1. Therefore, the functionality described previously with respect to controller 104 applies equally to controller 202.

In this embodiment, controller 202 includes at least one processor 204 communicatively coupled with at least one memory 206. In some embodiments, processor 204 executes programmed instructions (e.g., which may be stored at memory 206) in order to perform the functionality described herein for controller 202. In other embodiments, processor 204 and/or memory 206 comprises logic that implements the functionality described herein for controller 202.

In this embodiment, controller 202 further includes drivers 208. Drivers 208 are configured to modify the operation of LEDs 106. In particular, three drivers 208-1, 208-2, 208-N are illustrated in FIG. 2, each configured to modify the operation of a corresponding LEDs 106-1, 106-2, 106-N. However, in other embodiments, light 102 includes a different number of drivers 208-1, 208-2, 208-N and a different number of corresponding LEDs 106-1, 106-2, 106-N.

In this embodiment, drivers 208 are used to operate LEDs 106 of light 102 based on linear light values 116, and may also use calibration data 118. Processor 204 therefore may utilize drivers 208 in a number of different ways to control LEDs 106. For instance, drivers 208 may comprise multi-channel LED drivers, with each of drivers 208-1, 208-2, 208-N controlling a different color of LEDs 106. Thus, processor 204, using drivers 208, is configured in some embodiments to operate each color of LEDs 106 individually. For example, processor 204 may control each color of LEDs 106 and individually or collectively, adjust a brightness, a hue, and a saturation of LEDs 106 based on linear light values 116.

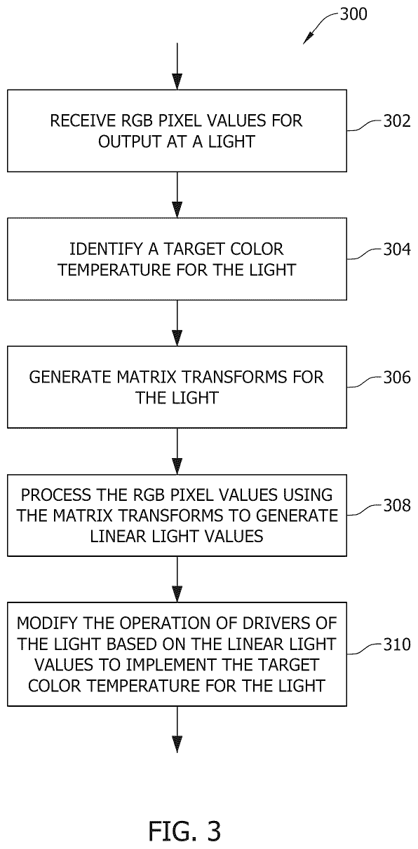

FIG. 3 depicts a flow chart of a method 300 operable by a controller of a light for dynamically adjusting a color temperature of the light in an exemplary embodiment. Method 300 will be discussed with respect to system 100 and controllers 104 and 202 of FIG. 1 and FIG. 2, respectively, although method 300 may be performed by other systems, not shown.

In this embodiment, method 300 comprises receiving 302, via at least one communication interface of the controller, a plurality of RGB pixel values for output at the light. For example, controllers 104, 202 and/or processor 204 receive RGB pixel values 112 via communication interfaces 110. In some embodiments, RGB pixel values 112 are included in DMX messages for light 102. In other embodiments, RGB pixel values 112 comprise a video stream of pixel values.

Method 300 further comprises identifying 304 a target color temperature for the light. In one example, controllers 104, 202 and/or processor 204 receive profile 120 via communication interface 110, and profile 120 specifies the target color temperature for light 102. In some embodiments, profile 120 comprises a DMX profile. In another example, controllers 104, 202 and/or processor 204 receive input from an end-user at user interface 108, and the input specifies the target color temperature for light 102. In other embodiments, the target color temperature is included as metadata associated with RGB pixel values 112.

Method 300 further comprises generating 306 one or more matrix transformations based on target color temperature for the light. For example, controllers 104, 202 and/or processor 204 generates matrix transforms 114 based on the target color temperature. Matrix transforms 114 may comprise, for example, color space transforms, chromatic adaptation transforms, and the like. Some examples of color space transforms include RGB color space transforms to or from XYZ color space, XYZ color space transforms to or from long, medium, short (LMS) color space, RGB color space transforms to or from LMS color space, etc. Some examples of chromatic adaptation transforms include von Kries based chromatic adaptation transforms and Bianco Schettini positivity constraint transforms. Further, matrix transforms 114 may be generated that use a chromatic adaptation matrix to modify linear R′G′B′ based on a relationship between a desired white point at light 102 and the white point defined by RGB pixel values 112 and/or a color space associated with RGB pixel values 112.

Method 300 further comprises processing 308 each of the plurality of RGB pixel values using the one or more matrix transforms to generate a plurality of converted RGB pixel values. For example, controllers 104, 202 and/or processor 204 process RGB pixel values 112 using matrix transforms 114 to generate linear light values 116. In some embodiments, converted RGB pixel values 112 are generated based on a plurality of processing steps in a process flow. For example, RGB pixel values 112 may be sequentially processed using an EOTF for light 102, processed by one or more matrix transforms 114 in a sequence to convert linear RGB data output by the EOTF to linear data for LED drivers 208, including utilizing one or more matrix transforms 114 to convert linear RGB to linear XYZ, linear XYZ to linear R′G′B′ generated by the Bianco Schettini positivity constraint transform, converting into and out of a LMS color space, the use of a chromatic adaptation matrix to modify linear R′G′B′ based on a relationship between a desired white point at light 102 and the white point defined by RGB pixel values 112, etc.

Method 300 further comprises modifying 310 the operation of at least one driver of the controller based on the linear light values to implement the target color temperature for the light. For example, controllers 104, 202 and/or processor 204 modifies the operation of drivers 208 based on linear light values 116 (and in some embodiments, calibration data 118), to implement the target color temperature of light 102.

FIG. 4 depicts a flow diagram 400 for dynamically adjusting a color temperature of a light in an exemplary embodiment. Flow diagram 400 will be discussed with respect to system 100 and controllers 104 and 202 of FIG. 1 and FIG. 2, respectively, although flow diagram 400 may be performed by other systems, not shown.

In this embodiment, a first set of operations 402 of flow diagram 400 are performed by one or more systems external to light 102, and a second set of operations 404 of flow diagram 400 are performed by light 102. The one or more systems external to light 102 may include, for example, one or more media servers that are external to light 102, etc.

At block 406, a DMX conversion is performed on RGB data 408 received by the media server. RGB data 408 may be similar to RGB pixel values 112, previously described.

The RGB data 408 may be generated, for example, by a video camera, a still camera, etc. RGB data 408 includes red, green, and blue channel values that may, for example, be defined by the international commission on illumination (CIE) 1931 RGB color space. The DMX conversion at block 406 converts RGB values for RGB data 408 to DMX channel integer values defined by a DMX profile for light 102 (e.g., profile 120).

The DMX conversion takes, as an input, a desired white point 410 for light 102 and original color space information 412 about the original color space of RGB data 408. In some embodiments, desired white point 410 may be entered by a user at light 102 using, for example, user interface 108. Desired white point 410 is a deviation of the white point desired at light 102 as compared to the white point as defined by RGB data 408 and/or original color space information 412. Original color space information 412 for RGB data 408 may be entered by a user and/or derived from metadata associated with RGB data 408. The media server may transmit the DMX data encapsulated in Ethernet frames to light 102, as shown in block 414, or transmit the DMX data via DMX transport protocol to light 102, as shown in block 416.

At block 418, controllers 104, 202 and/or processor 204 receive the DMX data from the media server (e.g., via Ethernet or the DMX protocol), along with the information regarding desired white point 410 and original color space information 412 (referred to as global parameter data), and recasts the DMX data in order to output, at block 420, RGB data 408 and the global parameter data.

At block 422, controllers 104, 202 and/or processor 204 utilize an EOTF to convert RGB data 408 to linear light values for light 102, and output linearized RGB at block 424. As discussed previously, the EOTF is a transfer function that converts RGB data 408 to linear light values for light 102.

At block 426, controllers 104, 202 and/or processor 204 convert the linearized RGB data to the CIE 1931 X, Y, Z color space (e.g., using one or more matrix transforms 114) based on the original color space information 412 and the CIE 1931 definition of RGB, and output linear X, Y, Z at block 428.

At block 430, controllers 104, 202 and/or processor 204 convert the linear X, Y, Z in the CIE 1931 X, Y, Z color space to a linear R′G′B′ using a chromatic adaption transform 432, one of matrix transforms 114 previously described, and output linear R′G′B′ at block 434. In this embodiment, controllers 104, 202 and/or processor 204 utilize the Bianco Schettini positivity constraint (BS-PC) matrix to implement chromatic adaptation transform 432, which is defined as:

$${M}_{BS - PC} = [ \begin{matrix}0.6489 & 0.3915 & - 0.0404 \\ - 0.3775 & 1.3055 & 0.0720 \\ - 0.0271 & 0.0888 & 0.9383\end{matrix} ]$$

At block 436, controllers 104, 202 and/or processor 204 utilize desired white point 410 to generate desired white point 410 in the X, Y, Z color space (X_{WP}Y_{WP}Z_{WP}).

At block 438, controllers 104, 202 and/or processor 204 convert X_{WP}Y_{WP}Z_{WP} to the R′G′B′ color space using chromatic adaptation transform 432, and output R′_{CCT}G′_{CCT}B′_{CCT} at block 440.

At block 442, controllers 104, 202 and/or processor 204 utilize an original color space white point 444 to generate original color space white point 444 in the X, Y, Z color space (Z_{CS}Y_{CS}Z_{CS}). Original color space white point 444 may be calculated based on original color space information 412 and/or RGB data 408.

At block 446, controllers 104, 202 and/or processor 204 convert Z_{CS}Y_{CS}Z_{CS} to the R′G′B′ color space using chromatic adaptation transform 432, and output R′_{CS}G′_{CS}B′_{CS} at block 448.

Using both R′_{CCT}G′_{CCT}B′_{CCT} output at block 440, and R′_{CS}G′_{CS}B′_{CS} output at block 448, controllers 104, 202 and/or processor 204 generate a chromatic adaptation matrix 450 based on the ratios R′_{CCT}/R′_{CS}, G′_{CCT}/G′_{CS}, B′_{CCT}/B′_{CS}. In particular, chromatic adaptation matrix 450, one of matrix transforms 114, comprises:

$${M}_{WB} = [ \begin{matrix}{R}_{ccs}^{′} / {R}_{cs}^{′} & 0 & 0 \\ 0 & {G}_{ccs}^{′} / {G}_{cs}^{′} & 0 \\ 0 & 0 & {B}_{ccs}^{′} / {B}_{cs}^{′}\end{matrix} ]$$

At block 452, controllers 104, 202 and/or processor 204 convert linear R′G′B′ to linear R′_{WB}G′_{WB}B′_{WB} using chromatic adaptation matrix 450, and output linear R′_{WB}G′_{WB}B′_{WB} at block 454.

At block 456, controllers 104, 202 and/or processor 204 convert linear R′_{WB}G′_{WB}B′_{WB} to linear X_{WB}Y_{WB}Z_{WB} using an inverse of chromatic adaptation transform 432, and output linear X_{WB}Y_{WB}Z_{WB} at block 458.

At block 460, controllers 104, 202 and/or processor 204 output image data at desired white point 410 utilizing drivers 208 and LEDs 106 (see FIG. 2). The image data may include still picture data and/or video data, based on RGB data 408 received by light 102.

An example technical effect of the embodiments described herein includes at least improving the IBL process when displaying image content on lights when the image content exhibits varying color temperatures.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for dynamically adjusting a color temperature of a light, the controller comprising:
at least one driver configured to modify an operation of at least one light emitting diode (LED) of the light;
at least one communication interface; and
at least one processor configured to:
receive, via the at least one communication interface, a plurality of red, green, and blue (RGB) pixel values for output at the light;
identify a target color temperature for the light;
generate one or more matrix transforms based on the target color temperature;
process the plurality of RGB pixel values using the one or more matrix transforms to generate a plurality of linear light values; and
modify, utilizing the at least one driver, the operation of the at least one LED based on the plurality of linear light values to implement the target color temperature for the light.

2. The controller of claim 1, further comprising:
at least one memory configured to store calibration data that specifies a pre-defined spectral output of the light,
wherein the at least one processor is further configured to:
modify, utilizing the at least one driver, the operation of the at least one LED based on the calibration data to implement the target color temperature for the light.

3. The controller of claim 1, wherein:
the one or more matrix transforms are configured to perform one or more color space transformations for the plurality of RGB pixel values.

4. The controller of claim 3, wherein:
the one or more color space transformations comprise one or more transformations between an RGB color space, an XYZ color space, a long, medium, short (LMS) color space, and a color space defined by a Bianco Schettini positivity constraint matrix transformation.

5. The controller of claim 1, wherein:
the one or more matrix transforms comprise a chromatic adaptation matrix having terms based on a ratio of the target color temperature and a color temperature of the plurality of RGB pixel values.

6. The controller of claim 1, wherein:
the at least one processor is further configured to receive, via the at least one communication interface:
a digital multiplex (DMX) profile that specifies the target color temperature; and
one or more DMX messages that include the plurality of RGB pixel values.

7. The controller of claim 1, further comprising:
a user interface,
wherein the at least one processor is further configured to receive, via the user interface, the target color temperature.

8. The controller of claim 1, wherein:
the one or more matrix transforms comprise a Bianco Schettini positivity constraint matrix.

9. A method operable by a controller of a light of dynamically adjusting a color temperature of the light, the method comprising:
receiving, via at least one communication interface of the controller, a plurality of red, green, and blue (RGB) pixel values for output at the light;
identifying a target color temperature for the light;
generating one or more matrix transforms based on the target color temperature;
processing the plurality of RGB pixel values using the one or more matrix transforms to generate a plurality of linear light values; and
modifying, utilizing at least one driver of at least one light emitting diode (LED) of the light, an operation of the at least one LED based on the plurality of linear light values to implement the target color temperature for the light.

10. The method of claim 9, wherein modifying the operation of the at least one LED further comprises:
modifying, utilizing the at least one driver, the operation of the at least one LED based on calibration data to implement the target color temperature for the light, wherein the calibration data specifies a pre-defined spectral output of the light.

11. The method of claim 9, wherein:
processing the plurality of RGB pixel values further comprises:
performing one or more color space transformations for the plurality of RGB pixel values using the one or more matrix transforms.

12. The method of claim 11, wherein:
performing the one or more color space transformations further comprises:
performing one or more transformations between an RGB color space, an XYZ color space, a long, medium, short (LMS) color space, and a color space defined by a Bianco Schettini positivity constraint matrix transformation.

13. The method of claim 9, wherein:
the one or more matrix transforms comprise a chromatic adaptation matrix having terms based on a ratio of the target color temperature and a color temperature of the plurality of RGB pixel values.

14. The method of claim 9, wherein:
identifying the target color temperature further comprises:
receiving, via the at least one communication interface, a digital multiplex (DMX) profile that specifies the target color temperature; and
receiving the plurality of RGB pixel values further comprises:
receiving one or more DMX messages for the light that include the plurality of RGB pixel values.

15. The method of claim 9, wherein:
identifying the target color temperature further comprises:
receiving, via a user interface of the controller, the target color temperature.

16. The method of claim 9, wherein:
the one or more matrix transforms comprise a Bianco Schettini positivity constraint matrix.

17. A system, comprising:
a light comprising at least one light emitting diode (LED); and
a controller comprising:
at least one driver configured to modify an operation of the at least one LED,
wherein the controller is configured to:
receive a plurality of red, green, and blue (RGB) pixel values for output at the light;
identify a target color temperature for the light;
generate one or more matrix transforms based on the target color temperature, wherein the one or more matrix transforms comprise a Bianco Schettini positivity constraint matrix and a chromatic adaptation matrix, and wherein the chromatic adaptation matrix has terms based on a ratio of the target color temperature and a color temperature of the plurality of RGB pixel values;
process the plurality of RGB pixel values using the one or more matrix transforms to generate a plurality of linear light values; and
modify, utilizing the at least one driver, the operation of the at least one LED based on the plurality of linear light values to implement the target color temperature for the light.

18. The system of claim 17, wherein:
the controller further comprises at least one memory configured to store calibration data that specifies a pre-defined spectral output of the light, and
wherein the controller is further configured to:
modify, utilizing the at least one driver, the operation of the at least one LED based on the calibration data to implement the target color temperature for the light.

19. The system of claim 17, wherein:
the controller further comprises at least one communication interface, and
the controller is further configured to receive, via the at least one communication interface:
a digital multiplex (DMX) profile that specifies the target color temperature; and
one or more DMX messages that include the plurality of RGB pixel values.

20. The system of claim 17, wherein:
the controller further comprises a user interface, and
the controller is further configured to receive, via the user interface, the target color temperature.
